(19) United States
(12) Patent Application Publication
(10) Pub. No.: US 2013/0235985 A1
(43) Pub. Date: Sep. 12, 2013

(54) SYSTEM TO IMPROVE AND EXPAND ACCESS TO LAND BASED TELEPHONE LINES AND VOIP

(71) Applicants: E. Daniel Christoff, Cary, NC (US); David Grant Rowe, Flinders Park (AU); Dave Rubenstein, New York, NY (US); Albert G. Sturm, San Jose, CA (US)

(72) Inventors: E. Daniel Christoff, Cary, NC (US); David Grant Rowe, Flinders Park (AU); Dave Rubenstein, New York, NY (US); Albert G. Sturm, San Jose, CA (US)

(21) Appl. No.: 13/415,684

(22) Filed: Mar. 8, 2012

(51) Int. Cl. H04M 11/00

(52) U.S. Cl. 379/90.01

(57) ABSTRACT

A system for expanding access to PSTN based telephone lines (landlines). The system can achieve landline reliability and superior voice quality similar to Skype or VoIP at computing devices such as desktops, laptops, smartphones (e.g., Blackberries®, iPhones®, PDAs), cell/mobile phones, tablets, and the like, by allowing landline calls to and from such computing devices. The PSTN landline connection can be used for placing or receiving calls through such computing devices, and can be made available at alternate external fixed and mobile locations, i.e., at locations other than a standard wired or wireless telephone connected to a wall jack. A LandLink CPE is provided for connecting at least one computing device to the Public Switched Telephone Network (PSTN) for making calls.

### BACKGROUND OF THE INVENTION

1. Field of the Invention

The present invention generally relates to a system for improving and expanding access to land based telephone lines as well as to incoming and outgoing calls using VoIP (Voice over Internet Protocol). By virtue of the features of the present invention, greater convenience and enhanced modern user experience with traditional reliability can be achieved.

2. Related Art

Conventional wired and wireless landline telephones have a number of drawbacks, as does VoIP. These drawbacks include those relating to voice quality, call reliability, phone accessibility, device clutter, tediousness in dialing, poor ergonomics, and others, as explained further herein.

There exists, therefore, a need to provide a novel method for expanding access to land based telephone lines and VoIP that overcomes the above-noted and other drawbacks of the existing methods.

### SUMMARY OF THE INVENTION

The foregoing and other problems can be overcome by an improved method for expanding access to land based telephone lines and VoIP as disclosed in the present application, and also by systems, apparatuses, and programs that operate in accordance with the method.

FIG. 1 is an illustration of what the “LandLink” device of the present invention broadly accomplishes according to one aspect. As shown in FIG. 1, the present invention creates a WiFi wireless link from one's computer or smartphone to one's reliable office or home landline.

FIG. 2 highlights features of the LandLink device of the present invention in relation to both office use and home use. These features will be discussed in more detail below, but, in brief summary, the present invention can leverage reliable landline communication to provide high quality audio to one's smartphone or computer that is similar to wideband VoIP such as Skype. By virtue of these features, a user can use his smartphone as an extension to his landline, such that he can be anywhere within WiFi range in his home or office complex and make and receive calls over his reliable landline. A user can also use his fixed or portable computer, and by wired or wireless LAN connection, use the LandLink device of the present invention to make and receive calls over his reliable landline.

As particularly advantageous for office use (see also FIGS. 7, 8, and 9), additional devices which tend to clutter one's workspace can be reduced or eliminated. Through one's computer, on-screen “one click” dialing and access to Outlook® and other address books can be accomplished, thereby eliminating the need for a user to look up and manually dial a number. Un-tethered reliable landline access can be provided, such that the user essentially has a landline phone “in his pocket,” and without carrying an additional device, by using the LandLink device through his existing smartphone. The user can make or receive calls on his smartphone or computer routed through his landline, with near wideband voice quality and having features available such as one touch dialing.

Although VoIP services utilizing the public Internet as the call transport mechanism are becoming more and more widely used, dropped calls, garbled speech, talk-over due to latency, and other quality and reliability issues continue to hinder and frustrate the user. Often this is due to the limited shared bandwidth and the general purpose nature of the public Internet. Typically, telco-provided landline PSTN services (both traditional POTS and newer cable, fiber, or similar digital phone services) offer either a private analog circuit or a digital circuit that is highly optimized for real-time voice. Additionally, the PSTN backbone network is well established and also highly optimized for real-time voice. These telco-provided landline PSTN services offer a highly reliable call transport mechanism and consistently good voice quality and are not typically subject to the Internet VoIP issues mentioned above. Therefore, by virtue of the features of the present invention, landline reliability (see FIG. 4) can be achieved and Internet VoIP issues avoided, while providing PSTN call origination and termination along with the other benefits of the LandLink system at smartphones, PCs, and other computing devices. Accordingly, improved reliability can be realized, which can benefit both home and office use, or personal and business use.

Moreover, one of the main disadvantages of SKYPE is that in order to use it, the party you wish to speak with must be on line, with SKYPE up as well. In contrast, with the LandLink invention, as long as the party you wish to speak with can answer their phone, you can connect.

The applicant will now describe the following problems which, as also described, can be overcome by the “LandLink” device of the present invention.

Inconvenient and/or unnatural access. Conventional wired and wireless landline telephones are tethered to fixed locations. While attempts have been made to make those locations convenient or central, such tethering nevertheless presents significant limitations in convenience and timely access. Wireless telephones (e.g., 900 MHz, 2.4 GHz, DECT, etc.) offer some portability, but often are not conveniently accessible, especially for incoming calls, and are often either missing in action entirely or found with a dead battery. Scrambling to find the randomly placed wireless receiver that is ringing somewhere tends to be a common problem associated with these devices. This problem can be mitigated by the present invention. Another problem that can be mitigated by the present invention is interference between WiFi and traditional wireless phones.

The applicant notes that conventional wired and wireless or cordless landline telephones are becoming less and less central to our lives. This can help to exacerbate the above-noted and other problems, but to the applicant this also creates an opportunity to leverage the very devices that are displacing landline telephones—i.e., mobile and smartphones. As shown in FIG. 11, by virtue of the features of the present invention, a user's smartphone can ring when his home phone rings. The user can easily remove the smartphone from his pocket, answer the call, and have access to complete landline reliability. Making and receiving landline calls using the smartphone can therefore mean no searching for one's traditional wireless phones, no dead batteries, and no 3G minutes usage.

Thus, the present invention allows delivery of landline and VoIP calls to a wide range of devices that are already immediately accessible, e.g., on one's desk, on one's lap, in one's pocket, or in one's living room. Accordingly, the present invention can considerably mitigate the inconvenient-access issue.

The present invention can also facilitate flexible delivery of calls to alternative external fixed and mobile locations through forwarding and find-me/follow-me type functionality. See FIG. 10. The follow-me feature of the present invention allows one to, for example, receive one's landline calls via Wi-Fi in his hotel room while on the road. This can mean fewer missed calls. Other enhanced features include on-screen call waiting, on-screen caller ID, visual voice mail, and, due to the aural reconstruction and other speech processing features, enhanced speech intelligibility both for the general daily user population and especially for the hearing impaired.

The present invention also provides the ability to speak “to the computer screen” or over one's smartphone (as can be done with VoIP systems such as Skype) while still enjoying the reliability of the landline. See FIG. 3 which summarizes the hands free operation of the present invention. In the hands free operation, the speaker and microphone are those that are in one's computer. The user can speak and listen to the screen, thereby allowing his attention to be focused on the on-screen subject matter that may be pertinent to the call. The present invention is compatible with all computer headsets. Peripheral speakers and microphones may also be used for enhanced speakerphone performance. Thus, any computer can become a high quality speakerphone.

Call quality. Traditional delivery of phone calls involves filtering techniques which reduce fidelity and strip away some characteristics of the human voice. This can result in a duller bandwidth-limited sound, cause some reduction in voice clarity, and create a shallow listening experience, especially when compared to some of today's VoIP offerings such as Skype. The present invention uses enhanced bandwidth expansion/aural reconstruction, noise reduction, echo cancellation, and other techniques to improve important aspects of call quality and to increase the depth, clarity, and overall intelligibility of voice calls. FIG. 6 summarizes these features. The present invention can provide real time implementation of bandwidth expansion and aural reconstruction digital signal processing (DSP) in a way which replaces significant speech frequency content which was lost due to the filtering and bandwidth limitations imposed by the PSTN. This can return the speech signal to a state much closer to the speaker's original voice and provide for more intelligible speech and a more pleasurable, less fatiguing listening experience.

Device clutter. Today's typical workspace is centered around a computing device, rather than a telephone. Furthermore, with the proliferation of computing devices such as laptops, netbooks, and tablets, the central component of the workspace (see FIG. 7) is very portable and may often be used in alternate locations, which do not provide adequate facilities for telephone-based calls, or even convenient access to a wireless phone. The present invention provides the ability to deliver phone calls directly to the computing device that is already the focal point of the workspace, or to smart-phones and the like which are typically kept within easy reach in today's modern society. Thus, no traditional telephone or speakerphone is needed. This allows for additional flexibility and reduced clutter by requiring fewer devices within the fixed or portable workspace. Hands free and headset alternatives, as well as Bluetooth®, provide an enhanced communication experience.

Call dialing. With conventional methods, there is little or no ability to dial a number from an Outlook® or other address book and be connected to the desired party. The far majority of desktop and laptop users do not have the ability to touch dial the desired party and have the computer do the dialing and making the connection, as one might have on one's smartphone. Most users are used to touch dialing on their cell phone but do not have the same convenience from their desk. In many cases, users have to look up the number in their address book or on their cell phone and then dial the number on their landline phone, which can be a slow process. Or simply make the call from their cell phone for the sake of convenience. This can then cause the user to suffer the poor call quality and lack of connection reliability of the cell phone, drive up the cost of the user's cell phone bill, cause potential negative health effects from cell phone usage, or have a deleterious effect on the battery life of the user's cell phone.

With the present invention, one-touch dialing, like with one's cell phone, can be accomplished from one's computer screen. See FIG. 5 and the screen shot shown therein. Accordingly, there is no need for a user to look up a person's number and then dial it manually on his desk phone. This can save the time and hassle of manual dialing and even misdialing. The present invention is compatible with all major address books, including Outlook®. See FIG. 12 for an example screen shot of a LandLink address book, and see FIG. 13 for an example screen shot of how the present invention interfaces with the user to provide the user with his or her call history and list of contacts and favorites, etc.

Poor ergonomics. Unlike many traditional phones, computing devices and smartphones offer better ways to both initiate outbound calls and to “see” incoming and on-going calls. In addition, devices such as modern desktops, laptops, tablets, and smartphones offer a good speaker phone or other hands-free operation options. In cases in which a computing device is also being referenced for information during a call, the user is afforded the additional ergonomic benefit of concentrating on interacting with and managing only one device (i.e., talking to the screen). The present invention addresses this issue by delivering calls to a variety of devices so that the user may choose which device is the most appropriate for the task at hand.

Reliability and quality. Although alternative voice call delivery mechanisms are improving (e.g., Skype, Google Voice, Vonage, generic VoIP, etc.), these are still dependent on shared public IP-based transmission infrastructures that must try to accommodate competing uses, including bandwidth intensive applications such as streaming media. Often, these calls are plagued by effects such as latency, echo, dropped speech, dropped calls, and other quality issues. The present invention can overcome this to bring the reliability and call quality benefits of landlines to computing devices. Due to the highly evolved and very reliable infrastructure, landline PSTN calls rarely drop or experience call quality problems due to telco network issues.

Inconvenient presentation. Calls delivered to a conventional phone often arrive with CallerID information. However, the process the user goes through, e.g., of finding the phone when it is ringing and then looking to see the small display, hinders the presentation of the call information. The presentation of call information on one's computer screen, smartphone screen, smart TV, or even audibly over the speakers can help increase the value of CallerID.

Installation location. Connecting a telephone line to a premises-based LAN (Local Area Network) can be problematic. If access to the telephone line is not near wired access to the LAN, physical installation and connection of an FXO CPE device (Foreign Exchange Office—Customer Premises Equipment) can be inconvenient, impractical, or even not feasible. Inclusion of WiFi in the CPE of the present invention allows for the device to be located near the telephone line access even if a wired LAN connection is not available.

Configuration burden. Configuring most VoIP devices can involve multiple settings, multiple steps, and sometimes requires significant networking and VoIP knowledge. Most consumers would find this difficult and frustrating, and most vendors would find the support burden too resource-intensive. Through the creative use of technologies like Wi-Fi Protected Setup, auto-discovery, local and cloud based provisioning techniques, the LandLink device of the present invention makes it possible to deliver a feature-rich platform with a low configuration burden.

Telcos under attack. Traditional telco operators are experiencing increasing pressure to stay relevant in the voice telephony market. Retaining and attracting subscribers for an infrastructure that is typically already paid for, and in some cases is even subsidized, is becoming both increasingly difficult and increasingly important. The LandLink device of the present invention offers these operators new and exciting benefits (as mentioned above and within), which helps the operators themselves, as well as their subscribers, by providing new ways to leverage the well-established and highly available existing telco PSTN infrastructures.

Inconvenient interruptions. Features such as CallerID, audible CallerID, anonymous call blocking, audible call screening can help manage both residential and home office/small office handling of incoming calls. However, such features are not universally available on already installed or even new traditional phone devices. The present invention offers the opportunity to both extend the use of these features in new ways and to add features not typically available in the residential or home office settings. (See FIG. 10.)

Telco provided voice mail (simultaneous call handling). In the event of an incoming PSTN call when there is already a call on the line, to avoid providing a busy signal, telco providers offer several solutions. These can include call waiting, call forwarding, busy/no answer, and telco-provided voice mail. In many scenarios, telco-provided voice mail is not desirable because it may be at a second location that the subscriber must check for voice mail. In conjunction with the telco call forwarding busy/no answer feature, the LandLink device of the present invention can allow for a more unified alternative by providing a PSTN (Public Switched Telephone Network) number which can be routed to the LandLink device voice mail system over broadband Internet. This can provide both a consistent outgoing message (for incoming callers) and a unified location and method for retrieving the voice messages. In addition, with close cooperation with the telco provider, the call or voice mail can be routed to the LandLink device without the need for an additional PSTN number.

Hearing impairment and telephone calls. Due to the previously noted call audio transport bandwidth limitation techniques applied at the edges and within both the fixed and mobile PSTN transport infrastructures, the call audio reaching the destination has had significant low and high frequency detail removed. This can have a significant negative intelligibility impact, especially on those with hearing impairments. In addition, the ranks of those falling into this category are dramatically expanding as the population ages. Through the bandwidth expansion, aural reconstruction, and equalization techniques of the present invention, enhanced audio can be provided that can allow for a significantly better listening experience for those with hearing impairments.

Simultaneous delivery of multiple incoming PSTN calls. A single PSTN line is capable of carrying only one simultaneous call due to its single audio path. Telcos attempt to mitigate this by offering call-waiting and call-waiting-callerID. This can offer value at times, but often it is disruptive and still requires a choice between which call to continue. In addition, if the call was intended for someone else in the household, there is typically no way to directly complete the call. By utilizing telco provided call-forward-no-answer in conjunction with call-waiting-callerID, the second call can be forwarded to an alternate PSTN number. The system of the present invention can then deliver the call to the LandLink CPE via VoIP where it can be answered by an alternative SIP or FXS destination (or still be processed by LandLink voice mail). In addition, with close cooperation with the telco provider, the call can be routed to the LandLink device without the need for an additional PSTN number.

In the applicant's view, the dominance of the desktop/laptop/tablet and smartphone in the home and workplace has created the need to overcome the above-noted and other problems.

The present invention therefore provides the ability to, inter alia:
achieve PSTN landline reliability and similar to Skype VoIP voice quality at computing devices such as desktops, laptops, smartphones (e.g., Blackberries®, iPhones®, PDAs, etc.), cell/mobile phones, tablets, and the like, by bringing landline calls to such computing devices;
use a PSTN landline connection for originating or receiving calls through computing devices instead of with, or in addition to, a standard wired or wireless telephone;
make a PSTN landline call available at alternate external fixed and mobile locations, i.e., at locations other than a standard wired or wireless telephone connected to a wall jack;
speak to and listen from a computing device for calls being carried by a PSTN landline connection;
place a call using a PSTN landline connection by touch dialing a party or having a party dialed automatically from a computing device.

The present invention in one embodiment provides a “LandLink” CPE for connecting computing devices to the Public Switched Telephone Network (PSTN) for making calls. The LandLink CPE includes one or more FXO ports connected to the PSTN; zero, one, or more FXS ports optionally connected to one or more POTS phones and/or the local premises telephone wiring; and a switch (at least in the embodiments in which an FXS port is included) for failover to a direct connection between PSTN and POTS phones in the event of a power outage, or based on user operating preferences. The LandLink CPE also includes echo cancellation, noise cancellation, aural reconstruction, and other units (such as automatic gain control) for processing signals received from the FXO and FXS to improve signal quality and voice intelligibility. Also included is a wired or wireless connection to computing devices, such that the computing device can make calls to and receive calls from the PSTN.

Further features and advantages of the present invention, as well as the structure and operation of various embodiments thereof, are described in detail below with reference to the accompanying drawings.

### BRIEF DESCRIPTION OF THE DRAWINGS

The features and advantages of the present invention will be more readily understood from a detailed description of the exemplary embodiments taken in conjunction with the following figures.

FIG. 1 is an illustration of what the “LandLink” device of the present invention broadly accomplishes according to one aspect.

FIG. 2 highlights features of the LandLink device of the present invention in relation to both office use and home use.

FIG. 3 summarizes the hands free operation of the present invention.

FIG. 4 summarizes the improved reliability that can be achieved with the present invention.

FIG. 5 summarizes the on-screen one-touch dialing features of the present invention.

FIG. 6 summarizes the high quality audio features of the present invention.

FIG. 7 shows how the present invention can reduce clutter in an office environment.

FIG. 8 summarizes features of the present invention in connection with a smartphone.

FIG. 9 highlights features of the present invention advantageous to an office environment.

FIG. 10 summarizes enhanced call features of the present invention.

FIG. 11 highlights features of the present invention advantageous to a home environment.

FIG. 12 is an example screen shot of a LandLink address book.

FIG. 13 is an example screen shot of LandLink on the user's computer screen.

FIG. 14 is a block diagram of a LandLink CPE device 30 according to an embodiment of the present invention.

FIG. 15 shows the processing of the echo cancellation unit 36 of the LandLink CPE device 30.

FIG. 16 shows the processing of the noise cancellation unit 38 of the LandLink CPE device 30.

FIG. 17 shows the processing of the aural reconstruction unit 40 of the LandLink CPE device 30.

FIG. 18 is a diagram showing the universe of the network in which the present invention operates, as well as various elements of the present invention, according to one embodiment.

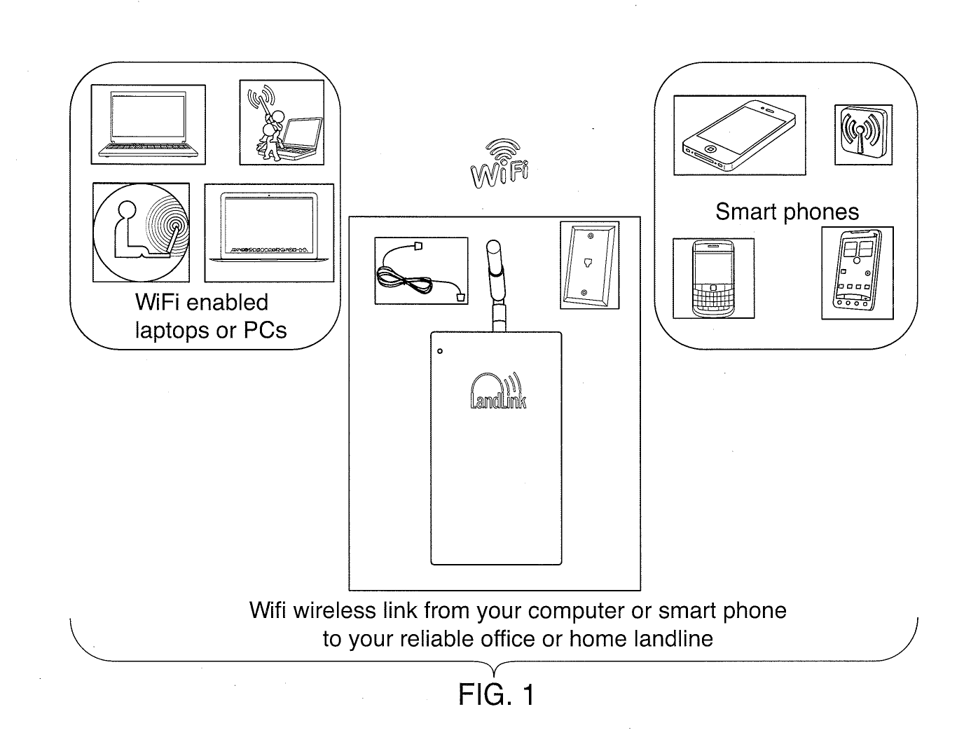

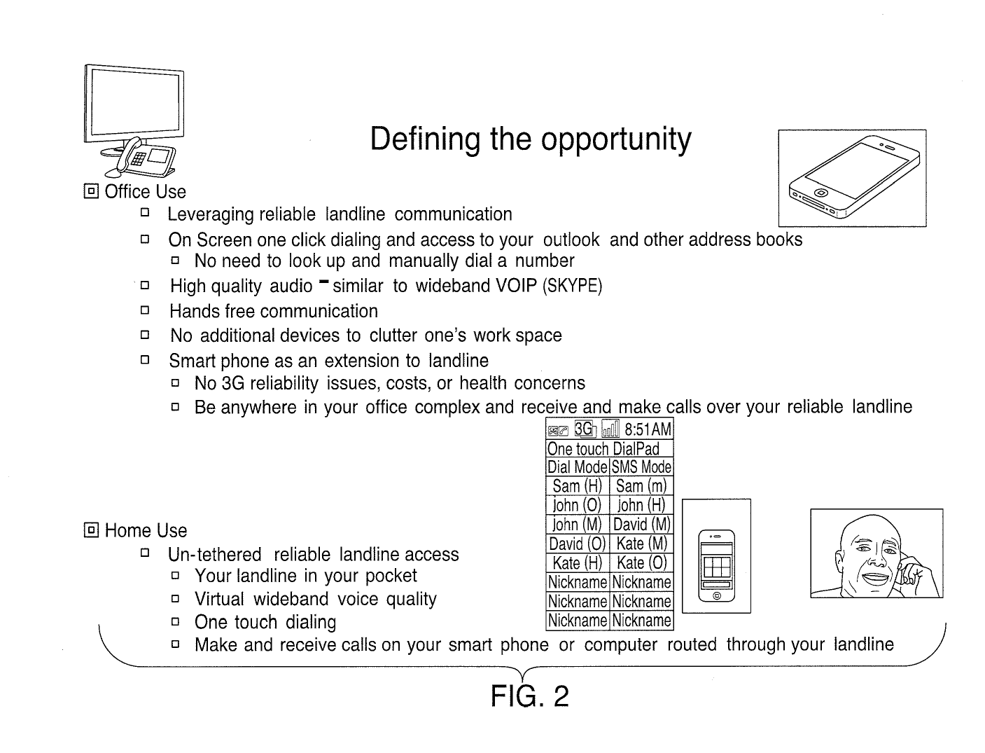

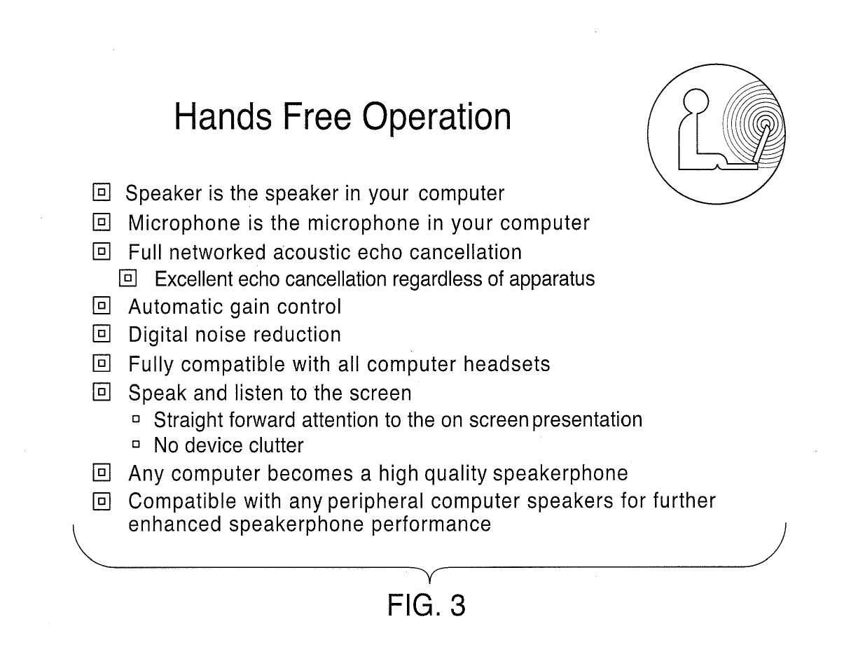

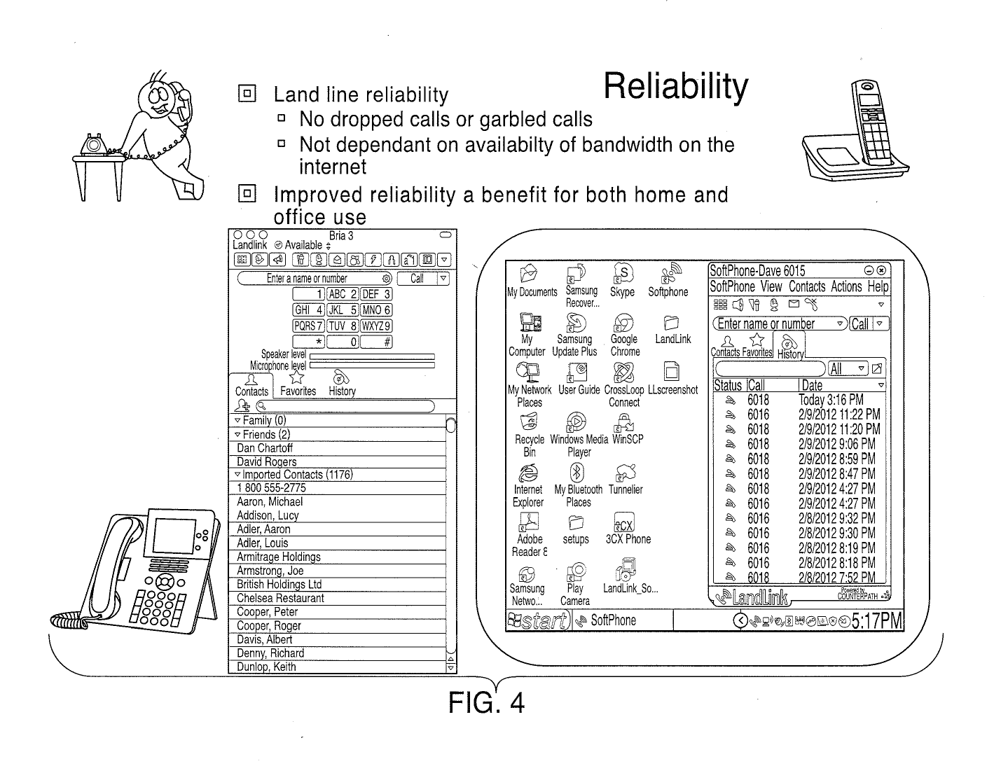

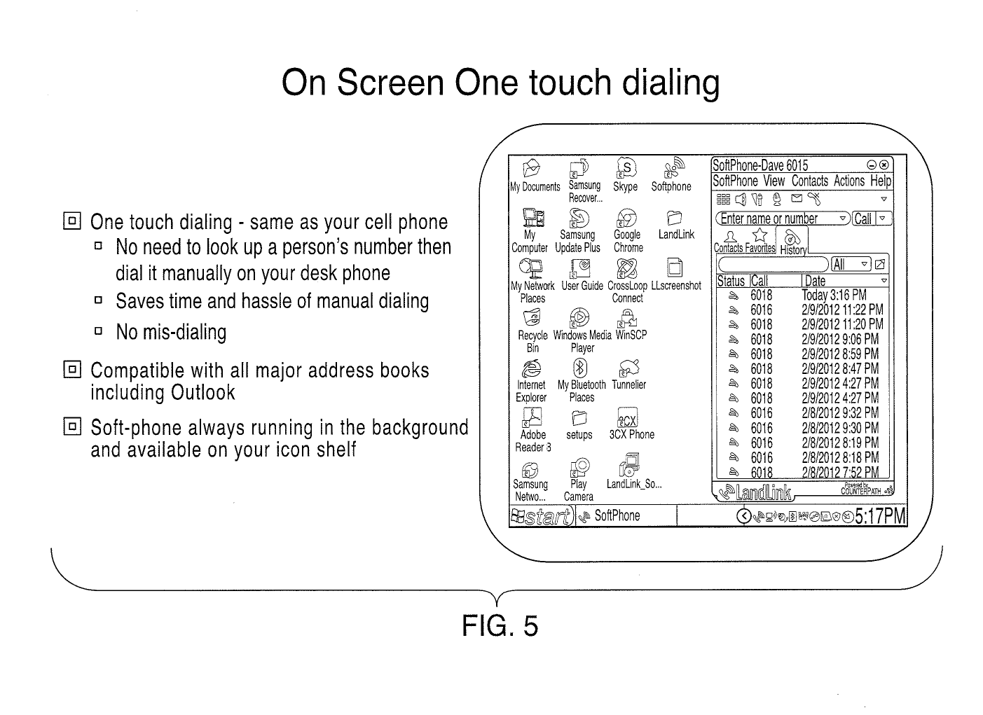

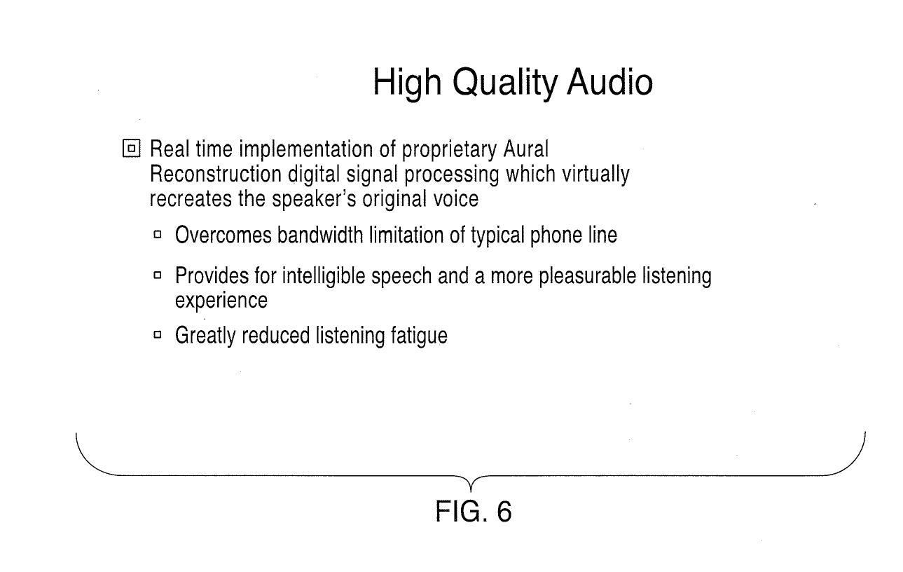

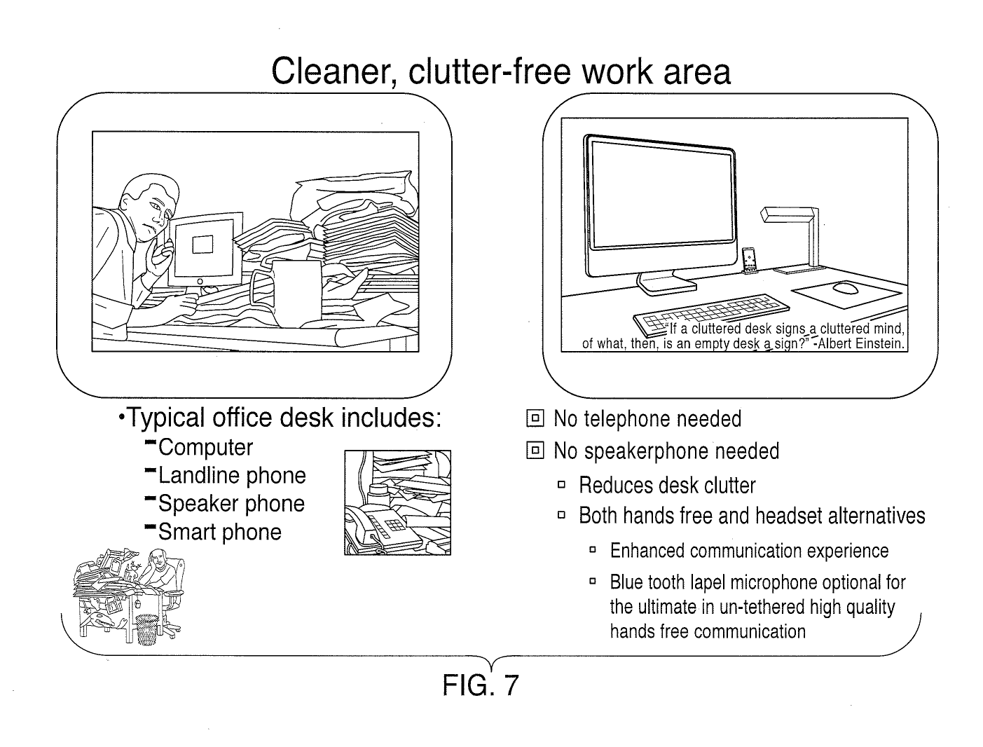

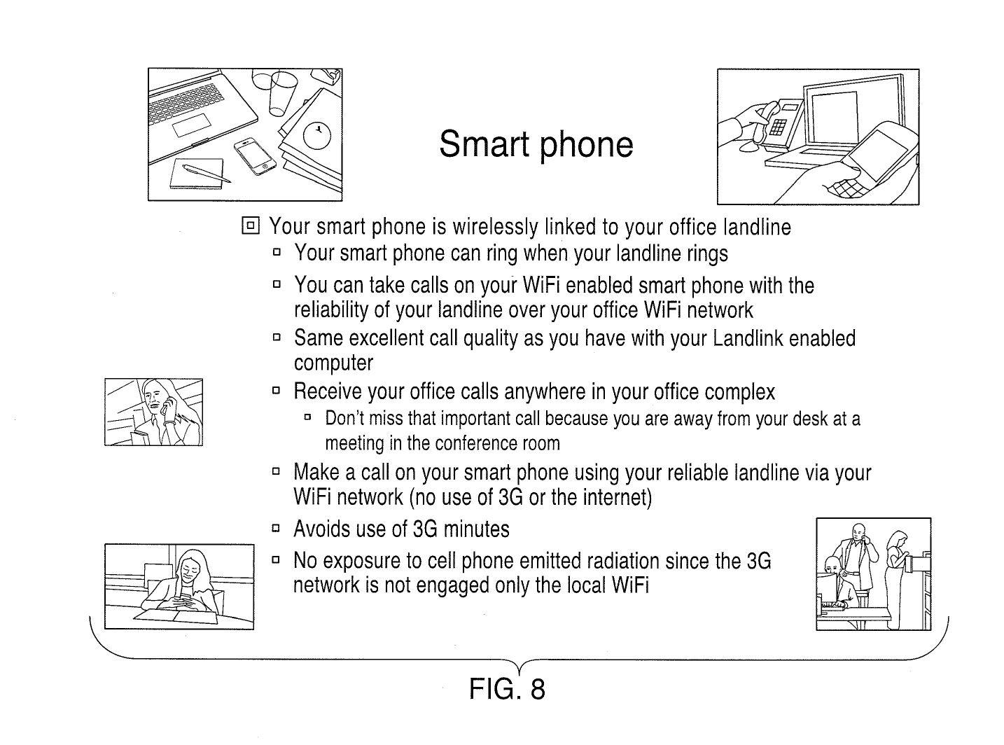

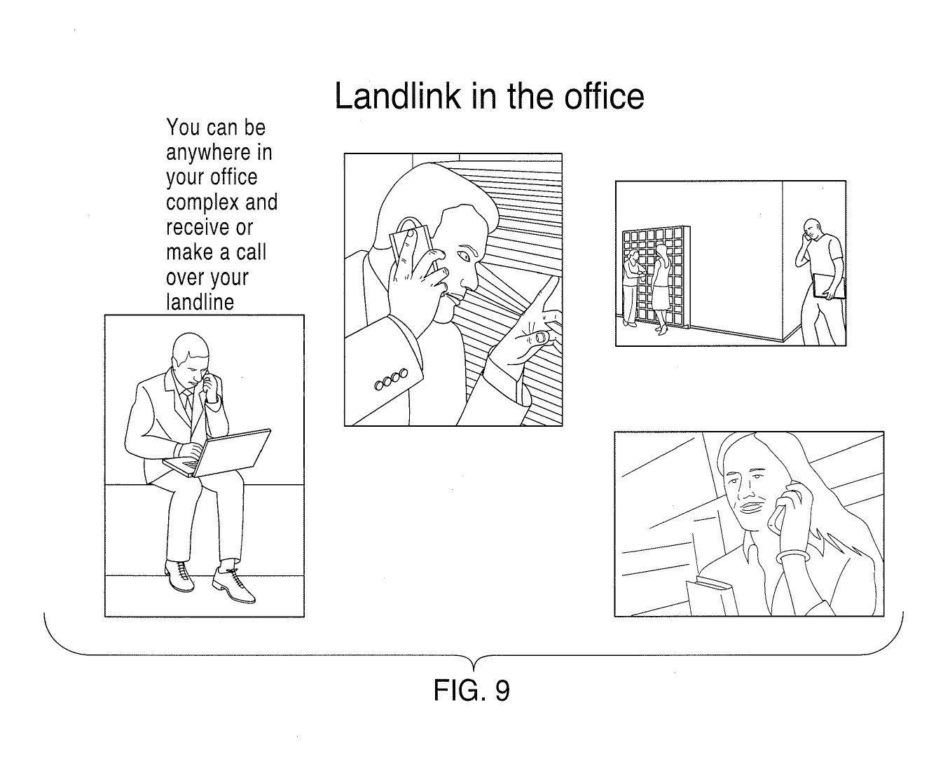

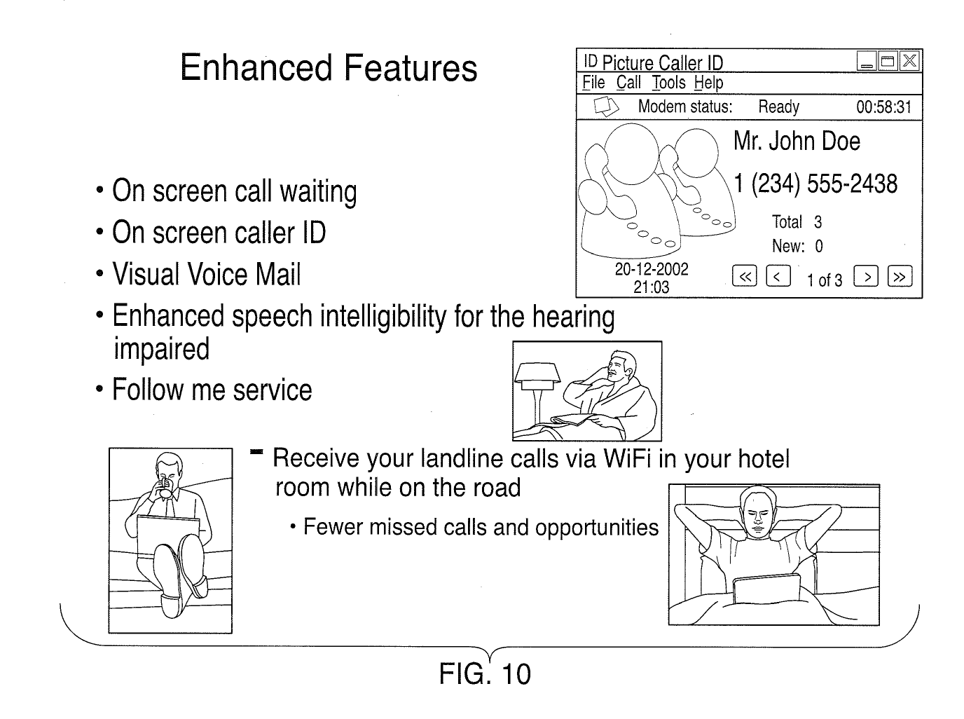

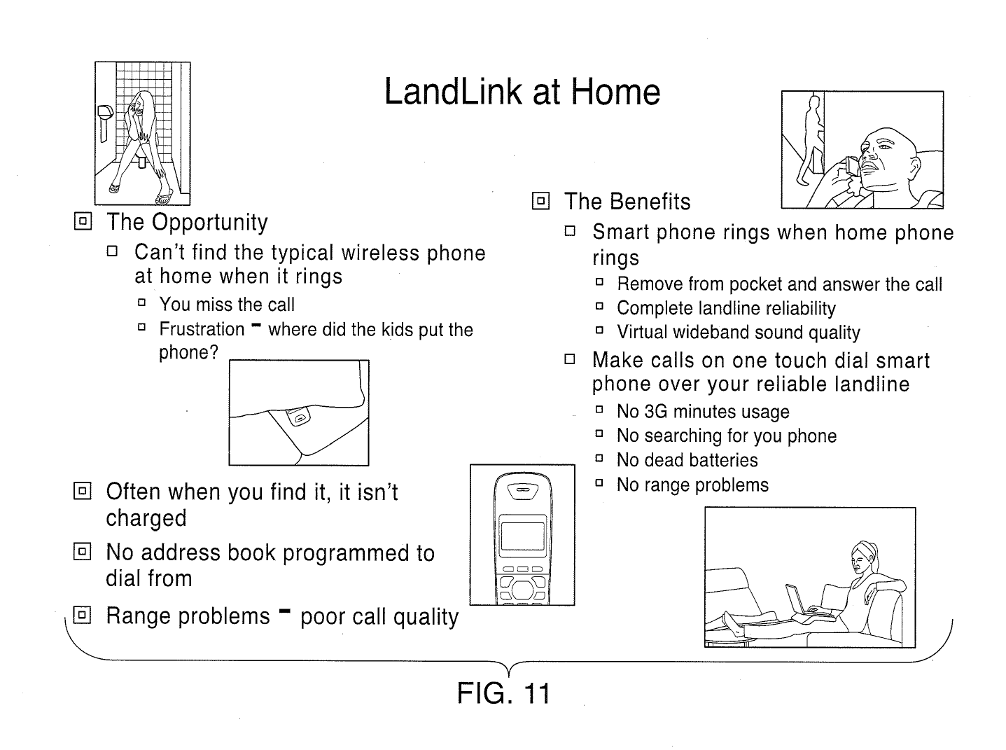

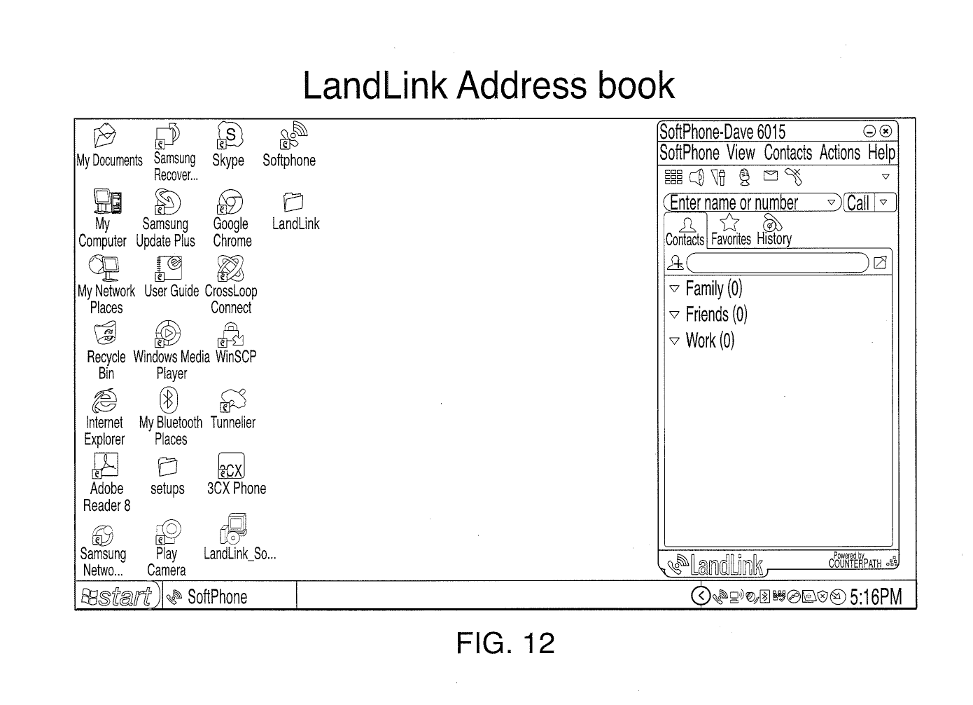

The invention will next be described in connection with certain exemplary embodiments; however, it should be clear to those skilled in the art that various modifications, additions, and subtractions can be made without departing from the spirit or scope of the claims.

### DETAILED DESCRIPTION OF THE PREFERRED EMBODIMENTS

As noted above, the present invention generally relates to a system for improving and expanding access to PSTN based telephone lines (landlines). The present invention provides a PSTN landline access point (FXO port). By virtue of the features of the invention, landline quality at computing devices can be provided by allowing landline calls to and from such computing devices.

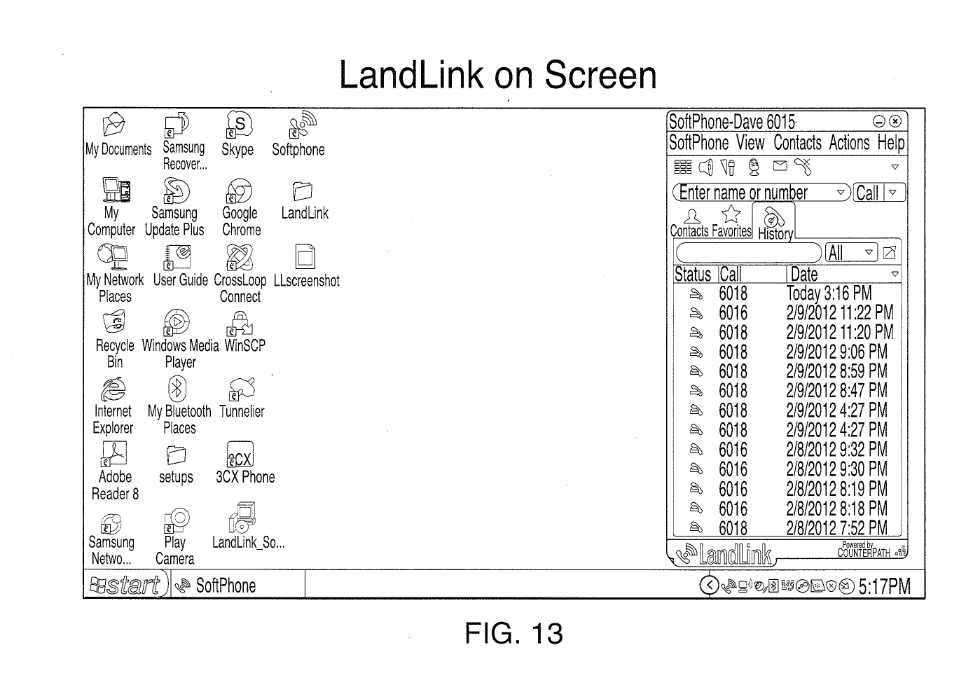

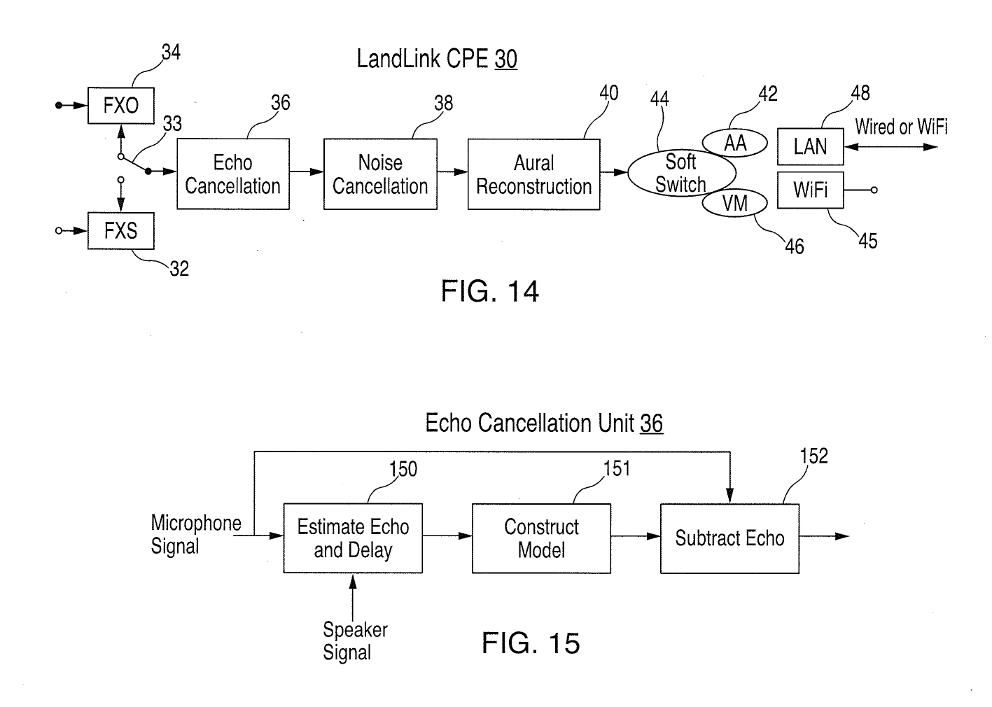

FIG. 14 is a block diagram of a LandLink CPE 30 (Customer-Premises Equipment or Customer-Provided Equipment) according to an embodiment of the present invention. In general, CPE refers to any terminal and associated equipment located at a subscriber's premises and connected with a carrier's telecommunication channel(s) behind the so-called “demarcation point.” This includes, for example, devices such as telephones, routers, switches, set top boxes, internet access gateways, and the like. This enables consumer access to Communications Service Provider services.

The LandLink CPE 30 includes FXS 32 and FXO 34. An FXS (Foreign eXchange Station) is a telephone interface (provided, for example, by a telephone company to its customers) that supplies battery power, provides dialtone, and generates ringing voltage. For example, a standard jack on a customer's wall is an FXS interface. A device that connects to such an interface contains an FXO (Foreign eXchange Office) interface and could be, for example, a standard analog telephone or a PBX (Private Branch eXchange) to receive telephone services. The plug on a telephone is an FXO interface, which provides on-hook/off-hook loop closure to the telephone company. Thus, an FXO phone plugs into an FXS jack.

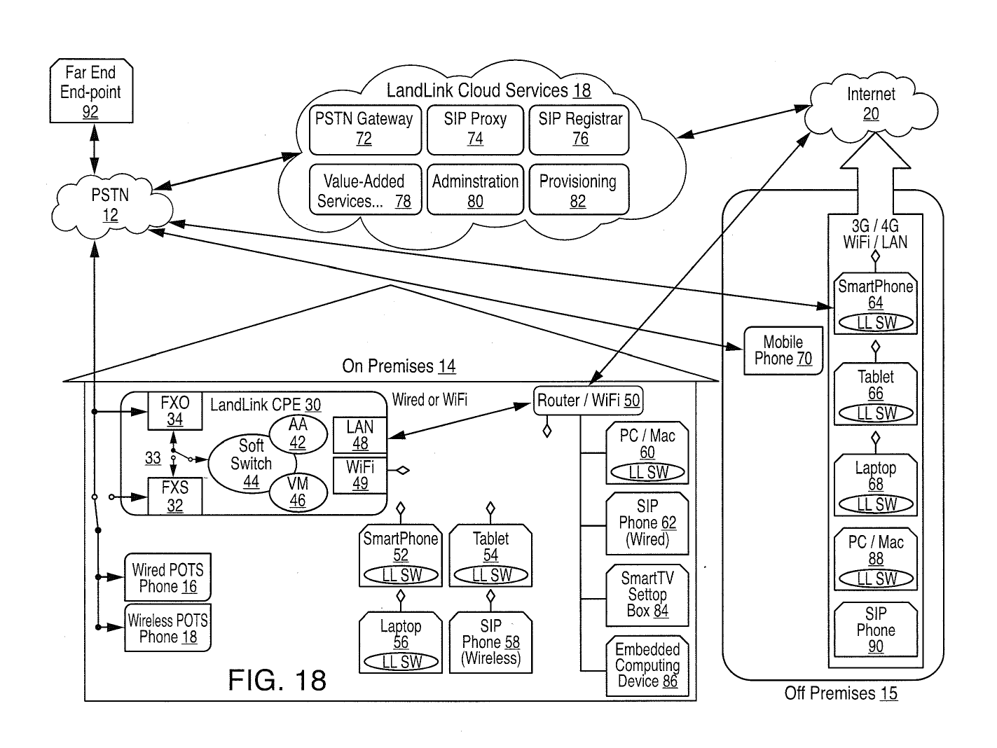

The LandLink CPE 30 also includes (at least in the embodiments in which an FXS port is included) a switch 33 for failover to a direct connection between PSTN 12 and POTS phones 16, 18 in the event of a power outage, or based on user operating preferences. The direct PSTN connection can also be accommodated outside of the LandLink CPE 30 by user wiring preferences. As shown in FIG. 18 (discussed in more detail below), the LandLink CPE 30 is connected to the PSTN 12. The signal is processed by an echo cancellation unit 36, a noise cancellation unit 38, an aural reconstruction unit 40, and other units (such as, e.g., automatic gain control) to improve its quality and speech intelligibility. While these units are shown in FIG. 14 in the order illustrated, it is of course to be understood that variations of this order can be made.

The present invention in units 36, 38, and 40 makes use of acoustic processing techniques which provide quality, hands-free communication. These units 36, 38, and 40 will be further described below. They make use of functions including echo cancellation, dual channel mixing, post filtering, high frequency encoding, noise reduction, low frequency reconstruction, and various equalization and automatic gain control and soft limiting techniques. By virtue of these features in conjunction with the other features described herein, better than landline voice quality can be achieved at computing devices such as desktops, laptops, smartphones (e.g., Blackberries®, iPhones®, PDAs), cell or mobile phones, tablets, and the like, by allowing landline calls to and from such computing devices.

The LandLink CPE 30 also includes AA 42, Soft Switch 44, VM 46, LAN 48 (Local Area Network), and WiFi 50. AA 42 (Auto Attendant) is software that replaces a human operator and directs callers to the appropriate extensions or voice mailboxes (e.g., “Press 1 for Sales, 2 for support . . . ”). Soft Switch 44 is software that can switch telephone calls, for example between two telephones. This is a software implementation of a traditional Private Branch eXchange (PBX). VM 46 (Voice Mail) is a computerized telephone answering system that digitizes incoming voice messages and stores them to flash memory.

A wired or WiFi connection connects the signal to a computing device (desktop, laptop, smartphone, etc.), as shown in more detail with regard to FIG. 18, which illustrates a wired or wireless connection through a LAN 48 or WiFi 49 to one or more personal computing devices such as SmartPhone 52, Tablet 54, Laptop 56, wireless SIP (Session Initiated Protocol) phone 58, PC/Mac 60, and wired SIP phone 62. As also shown in FIG. 18, these personal computing devices can be connected to the PSTN 12 either through an internet connection 20 to the LandLink CPE 30 or through an internet connection 20 to the LandLink cloud services 18.

For connecting a computing device such as a computer or smartphone, etc., to the LandLink CPE 30, a LandLink Softphone (LLSP) application can be installed on the computing device. The first time LLSP runs, the user will provide unique login information. The login information will be used to contact a provisioning server, authenticate, and then download various configuration information. This information will include, among other things, the instructions for connecting to the local LandLink CPE.

The software in the LandLink CPE 30 significantly enhances the perceptual quality of the phone calls using advanced digital signal processing techniques, including noise cancellation, acoustic echo cancellation, and aural reconstruction. The combined effect of the present invention is a phone call over the PSTN with voice quality better than PSTN and approaching wideband VoIP. This quality is achieved using a higher level of reliability than a VOIP call as it employs the voice optimized PSTN network rather than the bandwidth variability of the public Internet.

In more detail, the echo cancellation unit 36 of the LandLink CPE 30 (see FIG. 14) removes acoustic echo introduced by acoustic coupling between the speaker and microphone signals on the personal computing device 52, 54, 56, 58 (smartphone, tablet, laptop, SIP phone), etc. As shown in the flowchart of FIG. 15, it first estimates the echo 150 by comparing the signal sent to the speaker of the personal computing device with the signal received from the microphone of the personal computing device. Digital Signal Processing (DSP) software in the echo cancellation unit 36 then constructs a model 151 of the echo. This model is subtracted 152 from the signal received from the microphone of the personal computing device. This can ensure that an echo free signal is sent out of the FXO port 34 to the PSTN 12, thereby enhancing the quality of the speech perceived by a far end party 92 connected to the PSTN 12.

A notable feature of the echo cancellation unit 36 is the ability to estimate and cancel echo at an intermediate point in the network. Conventional echo cancellation is performed close to the microphone and speaker of the personal computing device, for example, in the firmware of the personal computing device. By virtue of implementing the echo cancellation unit 36 inside of the LandLink CPE 30, the microphone and speaker signals can have large (e.g., 500 to 1000 ms) delay and variable delay (due to IP packet jitter). This is known as network echo cancellation. An advantage of using network echo cancellation (i.e., inside of the LandLink CPE 30) is that echo can be removed from the audio received by all near end audio end-point devices, independently of each near end device's echo control systems and the near end device's echo path.

This network-based acoustic echo cancellation also offers the notable capability of removing irritating echo from the far end party 92 connected to the PSTN 12. This can be a particularly annoying type of echo since it is outside of the near-end listener's control to mitigate. Combined with other DSP algorithms, the LandLink CPE 30 can thus ensure a uniform high quality experience for both near-end and far-end listeners on the call. By placing AEC software on the LandLink CPE 30, the present invention can remove the variability in echo suppression that is experienced from different near end-point phone software/hardware combinations.

The noise cancellation unit 38 removes noise from the microphone signal on the personal computing device 52, 54, 56, 58 (smartphone, tablet, laptop, SIP phone), etc. This can ensure that a largely noise free signal is sent out of the FXO port 34 to the PSTN 12, thereby enhancing the quality of the speech perceived by the far end party 92 connected to the PSTN 12. Since this also is network-based, both the near-end and far-end listeners can benefit.

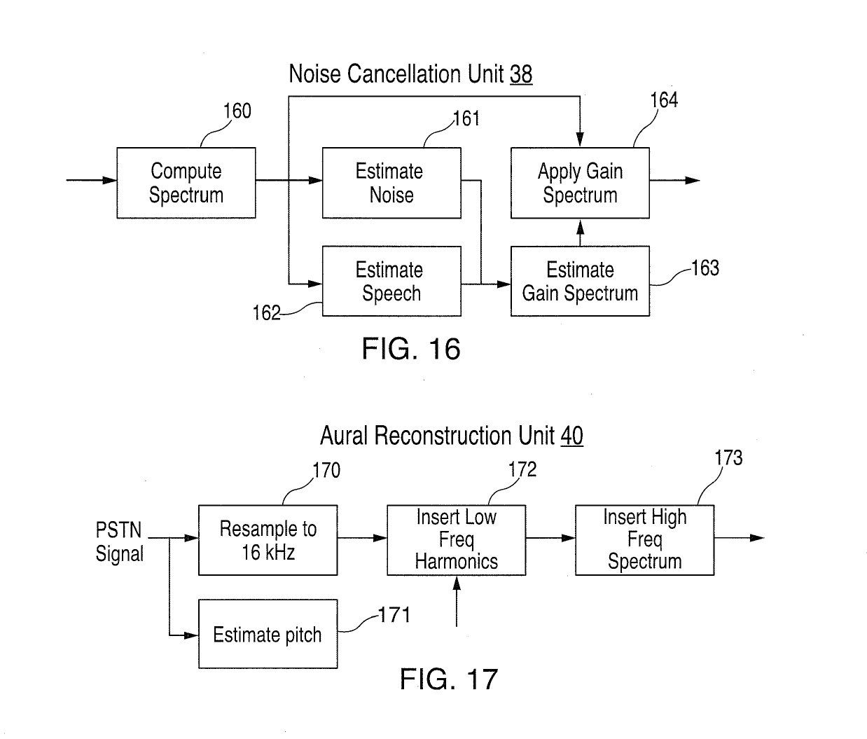

As shown in the flowchart of FIG. 16, the noise cancellation unit 38 analyzes the combined noise and speech signal from the spectrum of the microphone signal 160 on the personal computing device. The signal is resolved into an estimate of the noise spectrum 161 and an estimate of the speech spectrum 162 (the frequency components of the speech signal). This is used to compute a gain spectrum 163 which is applied to the combined signal 164. The gain of noise-only spectral components is reduced, while speech spectral components are allowed to pass through unchanged.

The aural reconstruction software takes a 300-3300 Hz band limited PSTN signal sampled at 8000 Hz and converts it to a wideband 50-7000 Hz signal sampled at 16000 Hz, using heuristic algorithms. This can provide the user with a perception of wideband speech, with the reliability advantages of using the PSTN for the call rather than VOIP over the Public Internet.

In more detail, the aural reconstruction unit 40 of the LandLink CPE 30, in one example embodiment of the present invention, takes 300 to 3300 Hz band limited, 8 kHz sampled speech from the FXO port 34 connected to the PSTN 12, and enhances the speech by re-sampling to 16 kHz (170) and inserting estimates of the original spectral components beneath 300 Hz and above 3300 Hz using heuristic algorithms. This enhances the quality of the speech perceived by the user of the personal computing device 52, 54, 56, 58 (smartphone, tablet, laptop, SIP phone), etc.

The low frequencies are reconstructed by generating estimates of the low frequency harmonics of speech. Voiced speech (e.g., vowels), are comprised of harmonics of the pitch. As shown in the flowchart of FIG. 17, first the fundamental frequency (pitch) of the speaker is estimated 171. By example, if a male speaker has a pitch of 100 Hz, the aural reconstruction unit 40 will insert the fundamental pitch of 100 Hz and then the first harmonic of 100 Hz, 172, which is at 200 Hz. Harmonics of 300 Hz and above will already be present in the pass band speech. The amplitude of the low frequency harmonics is estimated by interpolating the amplitude of the known harmonics at 300 Hz and above. The high frequencies components 173 are recreated through an estimation of a combination of low level, non-linear distortion and minoring of the low frequency spectrum and are inserted along with the original speech accordingly.

The present invention uses a newly developed FXO port driver that incorporates previously established FXO functionality as well as the addition of CallWaiting CallerID (CWID).

FIG. 18 is a diagram showing the universe of the network in which the present invention can operate, as well as various elements of the present invention, according to one embodiment.

Reference numeral 14 of FIG. 18 shows the On Premises aspect of the present invention. The On Premises aspect includes the LandLink CPE device 30. As shown, the LandLink CPE device 30 is connected to the PSTN 12. This connection can be made, for example, via a phone jack on the wall. The jack can also of course accommodate a wired POTS telephone 16 or a wireless POTS telephone 18. POTS, as known in the art, is an acronym for Plain Old Telephone Service, which is the voice-grade telephone service that remains the basic form of residential and business service connection to the public switched telephone network in most parts of the world.

In FIG. 18, “LL SW” refers to the LandLink VoIP softphone client and/or optionally other software used to provide call control, event notifications, media termination, and other functions useful for allowing broader access and use of the LandLink system.

Accordingly, as can be seen from FIG. 18, and by virtue of the features of the present invention, personal computing devices (such as 52, 54, 56, 60), VoIP SIP devices (such as 58, 62), and embedded computing devices (such as 84, 86) may make and/or receive calls and/or receive call information to/from the PSTN 12 through the LandLink CPE 30 and a LAN 48 or WiFi 49 connection.

The present invention also has an Off Premises aspect 15, to provide the ability to connect Off Premises computing or VoIP devices such as Smartphone 64, Tablet 66, Laptop 68, Desktop PC/Mac 88, SIP Phone 90 to calls and call information on the PSTN 12. Such personal computing devices can be connected to calls and call information on the PSTN 12 either through an internet connection 20 to the LandLink CPE 30, which of course provides the echo cancellation, noise cancellation, aural reconstruction, and other features as herein described such as automatic gain control, or through an internet connection 20 to the LandLink cloud services 18. The LandLink cloud services 18 include, but are not limited to, a PSTN Gateway 72, SIP Proxy 74, SIP Registrar 76, Value-Added Services 78, Administration services 80, and Provisioning services 82.

The PSTN Gateway 72, SIP Proxy 74, and SIP Registrar 76 of FIG. 18 work in concert with other typical VoIP components to provide both off premises VoIP access to the LandLink CPE 30 (including its landline connection, FXO 34), and to allow alternate VoIP based call routing to and from the PSTN 12. It is of course to be understood that FIG. 18 as shown is not intended to provide a complete description of internet/cloud based VoIP services, as there are other logical parts involved in the full system. For example, call routing functionality is generally under the control of a softswitch which typically includes call agent and media gateway components. Session border controllers are typically used to assist with signaling and media stream traversal between disparate public and private networks. The SIP Registrar 76 is primarily responsible for accepting REGISTER requests from SIP User Agents and updating a database with the current location (IP address) of the SIP User Agent. The SIP Proxy 74 acts as an intermediary which plays a role in routing calls between end-points and or gateways that otherwise do not have specific location information about the next destination in the call path. The PSTN Gateway 72 converts SIP signaling and the IP audio media stream to forms understood by the type of available connection to the PSTN 12.

The Value-Added Services 78 of FIG. 18 identify additional services that may optionally be provided to LandLink subscribers but which may not be initially included in the base LandLink system functionality. These may include but are not limited to such services as providing and routing calls for alternate or additional inbound PSTN phone numbers, voice mail to text transcription service, location-based emergency or other notification services, near real-time voice transcription as an adaptive technology for hearing impairment, biometric speaker verification, access to speech based command and control functions, etc.

The Administration Server 80 of FIG. 18 encompasses a broad range of functionality associated with activating and maintaining the LandLink system. Access from the end consumer may be by both generic web browser and/or specialized functionality contained within various LandLink Software components.

The Provisioning Server 82 of FIG. 18 allows for remote requests from various devices operating as part of the LandLink System, in order to establish and return licensing and various other parameters required for the devices to properly operate within the LandLink System. These devices may include but are not limited to LandLink CPE 30 and LandLink Software (LL SW) running on computing devices such as Smartphones 52, 64, Tablets 54, 66, desktop PCs or Macs 60, Laptops/Notebooks/Netbooks 56, 68, and SIP Phones 58. These devices will identify themselves and authenticate with a Provisioning Server 82 after which a reply with licensing and/or operating parameters will be returned.

The present invention or any part(s) or function(s) thereof, including the LandLink CPE device 30, the echo cancellation unit 36, the noise cancellation unit 38, and the aural reconstruction unit 40, may be implemented using hardware, software, or a combination thereof, and may be implemented in one or more computer systems or other processing systems. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The computer system can include a display interface that forwards graphics, text, and other data from the communication infrastructure (or from a frame buffer) for display on a display unit. The display interface can communicate with a browser. The computer system also includes a main memory, preferably a random access memory, and may also include a secondary memory and a database. The secondary memory may include, for example, a hard disk drive and/or a removable storage drive, representing a floppy disk drive, a magnetic tape drive, an optical disk drive, etc. The removable storage drive reads from and/or writes to a removable storage unit in a well known manner. The removable storage unit can represent a floppy disk, magnetic tape, optical disk, etc. which is read by and written to by the removable storage drive. As will be appreciated, the removable storage unit can include a computer usable storage medium having stored therein computer software and/or data. The computer system can also include a microphone and a speaker.

The computer system may also include a communications interface which allows software and data to be transferred between the computer system and external devices. The terms “computer program medium” and “computer usable medium” are used to refer generally to media such as the removable storage drive, a hard disk installed in the hard disk drive, and signals. These computer program products provide software to the computer system.

Computer programs or control logic are stored in the main memory and/or the secondary memory. Computer programs may also be received via the communications interface. Such computer programs or control logic (software), when executed, cause the computer system or its processor to perform the features and functions of the present invention, as discussed herein.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above-described exemplary embodiments, but should be defined only in accordance with the following claims and their equivalents.

In addition, it should be understood that the Figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the Abstract provided herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

Having described the invention, what is claimed as new and secured by Letters Patent is:

1. A LandLink customer premises equipment (CPE) for connecting at least one computing device to the Public Switched Telephone Network (PSTN) for making and receiving calls, comprising:
a landline access (FXO) port connected to the PSTN;
a foreign exchange station (FXS) port optionally connected to at least one plain old telephone service (POTS) phone and/or to local premises telephone wiring;
a switch for failover to a direct connection between the PSTN and the at least one POTS phone in the event of a power outage, or based on user operating preferences;
echo cancellation, noise cancellation, aural reconstruction units for processing signals received from or sent to the FXO port, the FXS port, and at least one computing or voice over internet protocol (VoIP) device to improve signal quality and voice intelligibility; and
a wired or wireless connection to the at least one computing device, such that the at least one computing device can make or receive calls through the PSTN.

2. The LandLink CPE of claim 1, wherein the at least one computing device is a desktop, a laptop, a smartphone, a cell phone, or a tablet.

3. The LandLink CPE of claim 1, wherein the echo cancellation unit removes acoustic echo introduced by acoustic coupling between the signal received from a microphone of the computing device and the signal sent to a speaker of the computing device by:
comparing the speaker signal with the microphone signal to estimate the echo;
constructing a model of the echo; and
subtracting the model of the echo from the microphone signal.

4. The LandLink CPE of claim 1, wherein the noise cancellation unit removes noise from the signal received from the microphone of the computing device by:
computing a spectrum of combined noise and speech in the microphone signal;
estimating a noise spectrum and a speech spectrum;
computing a gain spectrum from said estimating; and
applying the gain spectrum to the combined signal,
thereby reducing the gain of noise-only spectral components while allowing speech spectral components to pass through unchanged.

5. The LandLink CPE of claim 1, wherein the aural reconstruction unit enhances speech quality of the received PSTN signal by:
estimating a fundamental frequency of the speaker of the computing device;
converting the PSTN signal from 300-3300 Hz at 8 kHz to 50-7000 Hz at 16 kHz; and
inserting estimated low frequency harmonics beneath 300 Hz and high frequency components above 3300 Hz.

6. A system for connecting at least one computing device to the Public Switched Telephone Network (PSTN) for making and receiving calls, comprising:
a LandLink customer premises equipment (CPE), having:
a landline access (FXO) port connected to the PSTN;
a foreign exchange station (FXS) port optionally connected to at least one plain old telephone service (POTS) phone and/or to local premises telephone wiring;
a switch for failover to a direct connection between the PSTN and the POTS phone in the event of a power outage, or based on user operating preferences;
at least one of echo cancellation, noise cancellation, and aural reconstruction units for processing signals received from or sent to the FXO port, the FXS port, and at least one computing or (voice over internet protocol (VoIP) device to improve signal quality and voice intelligibility; and
a wired or wireless connection via LAN or WiFi to an on premises computing device, or to an off premises computing device through the Public Internet, such that the computing device can make or receive calls through the PSTN.

7. The system of claim 6, wherein the computing device is one of a desktop, a laptop, a smartphone, a cell phone, or a tablet.

8. The system of claim 6, further comprising a cloud connected between the at least one off premises computing device and the PSTN through the Public Internet, for providing services including PSTN gateway, SIP Proxy, SIP Registrar, Value-Added services, Administration, and Provisioning.

9. A LandLink CPE for connecting at least one computing device to the Public Switched Telephone Network (PSTN) for making and receiving calls, comprising:
a landline access (FXO) port connected to the PSTN;
echo cancellation, noise cancellation, aural reconstruction units for processing signals received from or sent to the FXO port and at least one computing or (voice over internet protocol (VoIP) device to improve signal quality and voice intelligibility; and
a wired or wireless connection to the at least one computing device, such that the at least one computing device can make or receive calls through the PSTN.

10. The LandLink CPE of claim 9, wherein the at least one computing device is a desktop, a laptop, a smartphone, a cell phone, or a tablet.

11. A method for connecting at least one computing device to the Public Switched Telephone Network (PSTN) for making and receiving calls, comprising:
connecting a landline access (FXO) port to the PSTN;
processing a signal received from the FXO port or from the at least one computing device to perform signal processing including at least one of echo cancellation, noise cancellation, and aural reconstruction to improve signal quality and voice intelligibility; and
forwarding the processed signal to the FXO port, or to the at least one computing device using a wired or wireless connection, such that the at least one computing device can make or receive calls through the PSTN.

12. The method of claim 11, wherein said echo cancellation processing removes acoustic echo introduced by acoustic coupling between the signal received from a microphone of the computing device and the signal sent to a speaker of the computing device, said echo cancellation processing comprising:
comparing the speaker signal with the microphone signal to estimate the echo;
constructing a model of the echo; and
subtracting the model of the echo from the microphone signal.

13. The method of claim 11, wherein said noise cancellation processing removes noise from the signal received from a microphone of the computing device, said noise cancellation processing comprising:
computing a spectrum of combined noise and speech in the microphone signal;
estimating a noise spectrum and a speech spectrum;
computing a gain spectrum from said estimating; and
applying the gain spectrum to the combined signal,
thereby reducing the gain of noise-only spectral components while allowing speech spectral components to pass through unchanged.

14. The method of claim 11, wherein said aural reconstruction processing enhances speech quality of the received PSTN signal, said aural reconstruction processing comprising:
estimating a fundamental frequency of the speaker of the computing device;
converting the PSTN signal from 300-3300 Hz at 8 kHz to 50-7000 Hz at 16 kHz; and
inserting estimated low frequency harmonics beneath 300 Hz and high frequency components above 3300 Hz.

15. A non-transitory computer-readable medium storing a program, which, when executed by at least one processor, causes the at least one processor to perform the processing of claim 11.

16. The system of claim 6, further comprising a router for connecting the LandLink CPE to the off premises computing device through the Public Internet.
